(19) United States
(12) Patent Application Publication
(10) Pub. No.: US 2015/0130931 A1
(43) Pub. Date: May 14, 2015

(54) POSITION DETECTING APPARATUS, AND LENS APPARATUS AND IMAGE PICKUP APPARATUS INCLUDING THE POSITION DETECTING APPARATUS

(71) Applicant: CANON KABUSHIKI KAISHA, Tokyo (JP)

(72) Inventor: Junji Shigeta, Utsunomiya-shi (JP)

(21) Appl. No.: 14/537,090

(22) Filed: Nov. 10, 2014

(30) Foreign Application Priority Data
Nov. 12, 2013 (JP) 2013-234387

(51) Int. Cl. G01D 5/347; G01B 11/14

(52) U.S. Cl. CPC G01D 5/34776; G01B 11/14
USPC 348/135; 702/150

(57) ABSTRACT

A position detecting apparatus, which detects a relative position, relative to a base member, of a movable member which relatively moves in a movement direction relative to the base member includes: a scale formed on one of the two members, the scale including first/second pattern arrays respectively including first/second patterns arranged in first/second cycle in the movement direction; an obtaining unit mounted on the other, and configured to obtain signals including first/second signals based on the first/second pattern arrays respectively; a position calculator configured to calculate an absolute position of the movable member; a determinator configured to determine whether the absolute position calculated by the position calculator is correct; and a memory configured to store an information for determining whether the absolute position is correct, wherein the determinator determines whether the absolute position calculated by the position calculator is correct based on the information stored in the memory.

### BACKGROUND OF THE INVENTION

1. Field of the Invention

The present invention relates to a position detecting apparatus configured to detect a position of a movable member, and to a lens apparatus and an image pickup apparatus including the position detecting apparatus.

2. Description of the Related Art

As an apparatus for measuring a distance of movement of an object, besides an incremental encoder for measuring a distance of relative movement, there is hitherto known an absolute encoder capable of detecting an absolute position.

Japanese Patent Application Laid-Open No. H8-304113 discloses a Vernier type absolute encoder. The Vernier type absolute encoder disclosed in Japanese Patent Application Laid-Open No. H8-304113 has a configuration including at least two grid patterns having different pitches on a track. Based on a slight shift between detected signals, which is generated due to a difference in pitch between the grid patterns, a position in a section over which the Vernier type absolute encoder circulates once is identified (hereinafter also referred to as “absolute position detection” or “absolute position calculation”).

Japanese Patent Application Laid-Open No. H5-45151 discloses timing of switching to an absolute counting operation in the Vernier type absolute encoder. The Vernier type absolute encoder has a configuration in which track patterns are formed at smaller pitches and at larger pitches. As the timing of switching to the absolute counting operation based on the tracks described above, when a speed is lowered to a speed at which erroneous detection does not occur in an incremental measurement at the smaller pitches, an operation of the Vernier type absolute encoder is switched to the absolute counting operation.

However, the absolute encoder disclosed in Japanese Patent Application Laid-Open No. H8-304113 has the following problem. In the case where motes and scratches are present on a scale, an absolute position is calculated based on a detection signal containing noise. As a result, there arises a problem in that a correct absolute position cannot be calculated.

Further, the absolute encoder disclosed in Japanese Patent Application Laid-Open No. H5-45151 has the following problem.

In the case where motes and scratches are present on a scale at a position at which the speed is lowered so that erroneous detection does not occur in incremental measurement with fine pitches, an erroneous detection signal is detected. As a result, an absolute position is also calculated based on the erroneous detection signal.

Further, the absolute encoder is incorporated in equipment, and hence it is difficult to determine a defect of the absolute encoder itself.

### SUMMARY OF THE INVENTION

It is an object of the present invention to provide a Vernier type position detecting apparatus having high reliability, which is capable of preventing erroneous absolute position calculation even in the case where motes and scratches are present on a track.

In order to achieve the above-mentioned object, a position detecting apparatus according to one embodiment of the present invention which detects a relative position, relative to a base member, of a movable member which relatively moves in a movement direction relative to the base member, including: a scale formed on one of the base member and the movable member, the scale including a first pattern array including a plurality of first patterns arranged in a first cycle in the movement direction and a second pattern array including a plurality of second patterns arranged in a second cycle different from the first cycle in the movement direction; an obtaining unit mounted on the other of the base member and the movable member, and configured to obtain a plurality of signals including a first signal based on the first pattern array and a second signal based on the second pattern array; a position calculator configured to calculate an absolute position of the movable member with respect to the base member based on the plurality of signals; a determinator configured to determine whether or not the absolute position calculated by the position calculator is correct; and a memory configured to store an information for determining whether or not the absolute position calculated by the position calculator is correct, wherein the determinator determines whether or not the absolute position calculated by the position calculator is correct, based on the information stored in the memory.

According to one embodiment of the present invention, in the Vernier type position detecting apparatus, the state of the absolute encoder can be checked outside by outputting information on the presence of motes and scratches on the track to the outside. Further, the position detecting apparatus having high reliability can be provided, which is capable of preventing erroneous absolute position calculation even in the case where motes and scratches are present on the track.

Further features of the present invention will become apparent from the following description of exemplary embodiments with reference to the attached drawings.

### BRIEF DESCRIPTION OF THE DRAWINGS

FIG. 1 is a configuration block diagram of a position detecting apparatus according to a first embodiment of the present invention.

FIG. 2 is a sectional view of an ABS sensor.

FIG. 3 is a plan view of a scale unit.

FIG. 4 is a plan view of a light receiver.

FIG. 5 is a flowchart of absolute position calculation.

FIG. 6A is a graph showing first and second relative position signals and a Vernier signal.

FIG. 6B is a graph showing first and second relative position signals and a Vernier signal.

FIG. 6C is a graph showing first and second relative position signals and a Vernier signal.

FIG. 6D is a graph showing first and second relative position signals and a Vernier signal.

FIG. 7A is a graph showing a waveform change in synchronism calculation.

FIG. 7B is a graph showing a waveform change in synchronism calculation.

FIG. 7C is a graph showing a waveform change in synchronism calculation.

FIG. 7D is a graph showing a waveform change in synchronism calculation.

FIG. 8A is a diagram illustrating a foreign matter on a scale and a pattern read area.

FIG. 8B is a diagram illustrating a foreign matter on a scale and a pattern read area.

FIG. 8C is a diagram illustrating a foreign matter on a scale and a pattern read area.

FIG. 9A is a graph showing a relationship between a movable member position and an absolute position value.

FIG. 9B is a graph showing a relationship between a movable member position and an absolute position value.

FIG. 10 is a flowchart showing recording of error detection information in the first embodiment.

FIG. 11 is a flowchart of absolute position determination in the first embodiment.

FIG. 12 is a configuration block diagram of a second embodiment of the present invention.

FIG. 13 is a flowchart illustrating update of error detection information in the first embodiment.

### DESCRIPTION OF THE EMBODIMENTS

Now, position detecting apparatus according to exemplary embodiments of the present invention are described in detail with reference to the accompanying drawings.

### First Embodiment

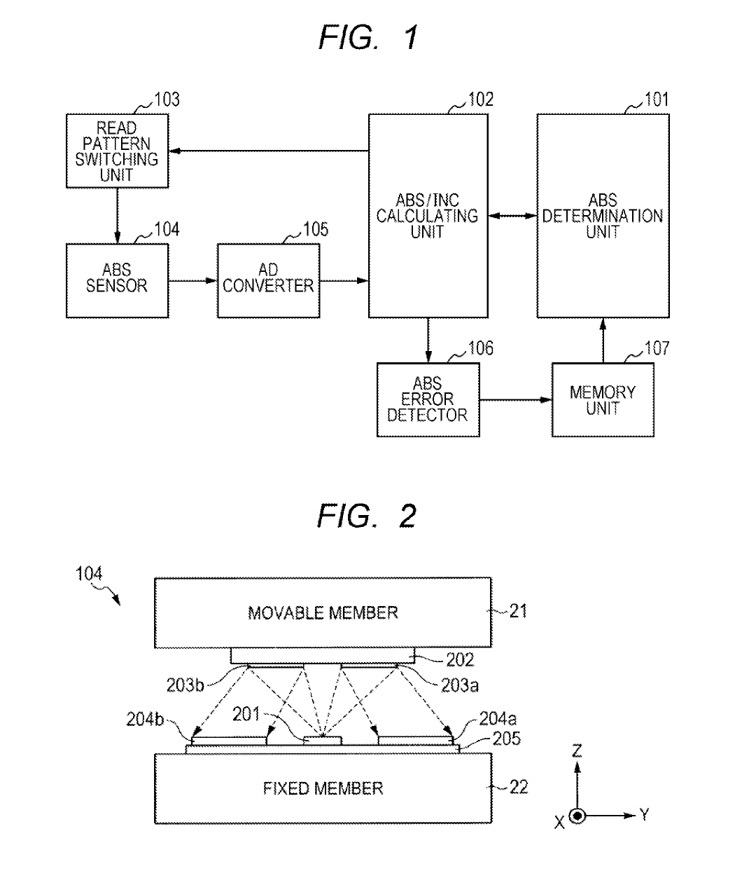

Now, a position detecting apparatus according to a first embodiment of the present invention is described with reference to FIG. 1.

FIG. 1 is a configuration block diagram according to the first embodiment. In FIG. 1, an ABS/INC calculator 102 (position calculator) is a calculator for calculating, based on a signal obtained from an ABS sensor 104, an absolute position value Pabs that is a position (absolute position) calculated based on a signal obtained at a position of a movable member with respect to a fixed member and a relative position value Pinc that is a displacement amount (relative position) from a certain position of the movable member with respect to the fixed member. The fixed member and the movable member have only to move relatively to each other. Therefore, the fixed member and the movable member serve conversely each other, or the fixed member and the movable member can be two movable members. The position detector of the present invention detects the positional relationship between the said two members based on the positional relationship between the scale mounted on one of the two members and the sensor (and a light source) mounted on the other of the two members. In other words, the position detector of the present invention detects the position of an object to be measure (movable member) with respect to a base member by use of a position information of the obtaining unit (which will be described later) with respect to the scale. A read pattern switcher 103 (obtaining unit) switches two types of signal outputs generated by two types of pattern arrays, which are output from the ABS sensor 104 (obtaining unit). The ABS sensor (obtaining unit) 104 is an absolute position sensor for outputting a signal for calculating an absolute position of the movable member with respect to the fixed member. An internal configuration and the output signals of the ABS sensor 104 are described later. An AD converter 105 is an AD converter for converting an analog signal output from the ABS sensor 104 into a digital signal. An ABS error detector 106 (determinator) is an absolute position error detector for detecting an error in the absolute position value Pabs based on the absolute position value Pabs and the relative position value Pinc calculated by the ABS/INC calculator 102 (position calculator). A method of detecting an error in the absolute position value Pabs by the ABS error detector 106 is described later. A memory unit 107 (memory) is a memory for holding error detection information Einfo that is information on the absolute position value Pabs at a time when it is determined that the absolute position value Pabs is not correct, and an EEPROM is given as an example. The error detection information Einfo is described later. An ABS determinator (absolute position determinator) 101 is an absolute position determinator for determining a present absolute position Pabsc based on the absolute position value Pabs and the relative position value Pinc calculated by the ABS/INC calculator 102 and the error detection information Einfo. The ABS determinator 101, the ABS/INC calculator 102, and the ABS error detector 106 are configured in a single CPU, for example.

Next, an operation of this embodiment is described. The ABS determinator 101 requests the ABS/INC calculator 102 to calculate the absolute position value Pabs. When receiving the absolute position calculation request from the ABS determinator 101, the ABS/INC calculator 102 issues a command to the read pattern switcher 103 so that signals corresponding to the two types of pattern arrays are successively output from the ABS sensor 104. The read pattern switcher 103 instructs the ABS sensor 104 to output two types of patterns of signals (described later) successively. The ABS sensor 104 outputs the signals corresponding to the two types of pattern arrays successively in accordance with the instruction from the read pattern switcher 103. The signals corresponding to the two types of pattern arrays output from the ABS sensor 104 are converted into digital signals by the AD converter 105 and output to the ABS/INC calculator 102. The ABS/INC calculator 102 calculates the absolute position value Pabs based on the signals corresponding to the two types of pattern arrays and outputs the absolute position value Pabs to the ABS determinator 101 and the ABS error detector 106.

On the other hand, the ABS/INC calculator 102 issues a command to the read pattern switcher 103 so that a signal corresponding to a pattern array required for calculating the relative position value Pinc is output from the ABS sensor 104. The ABS/INC calculator 102 switches to the signal corresponding to the pattern array required for calculating the relative position value Pinc, and thereafter, calculates the relative position value Pinc based on the signal corresponding to the pattern array output from the AD converter 105 in the same way as the above. Then, the ABS/INC calculator 102 outputs the relative position value Pinc to the ABS determinator 101 and the ABS error detector 106 periodically. The methods of calculating the absolute position and the relative position are described later. The ABS error detector 106 determines whether or not the absolute position value Pabs is correct based on the absolute position values Pabs and the relative position values Pinc at a plurality of positions. When determining that the absolute position value Pabs is not correct, the ABS error detector 106 stores the error detection information Einfo in the memory unit 107. A method of determining that the absolute position value Pabs is not correct by the ABS error detector 106 is described later. Further, the error detection information Einfo is also described later. The ABS determinator 101 determines an absolute position based on the error detection information Einfo, the relative position value Pinc, and the absolute position value Pabs. A method of determining an absolute position by the ABS determinator 101 is described later.

Next, the internal configuration and the output signals of the ABS sensor 104 are described.

FIG. 2 is a sectional view of the ABS sensor 104. In FIG. 2, a movable member 21 is a movable portion capable of moving in an X-axis direction which is vertical to a paper plane. A fixed member 22 is a member which serves as a reference of the absolute position of the movable member 21. A light source 201 is a light emitting unit, and is, for example, an LED. A scale unit 202 is a scale unit including two pattern arrays 203a and 203b having different numbers of slits provided at equal intervals over a total length. A light receiver 204a is a light receiver for receiving light which is emitted from the light source 201 and reflected by the pattern array 203a. Similarly, a light receiver 204b is a light receiver for receiving light which is emitted from the light source 201 and reflected by the pattern array 203b. The light receivers 204a and 204b are, for example, photodiode arrays. A signal processing circuit 205 is configured to process the signals of the light received by the light receivers 204a and 204b and to output the signals corresponding to any of the pattern arrays 203a and 203b in accordance with a switch-over signal from the read pattern switcher 103. In this embodiment, the configuration in which the scale unit 202 is provided to the movable member 21 and the light source 201 and the light receivers 204a and 204b are provided to the fixed member 22 is exemplified. However, it should be understood that the present invention is not limited thereto. The scale unit 202 only needs to be provided to one of the fixed member and the movable member, whereas the light source 201 and the light receivers 204a and 204b only need to be provided to the other of the fixed member and the movable member. The same also applies to an embodiment described later.

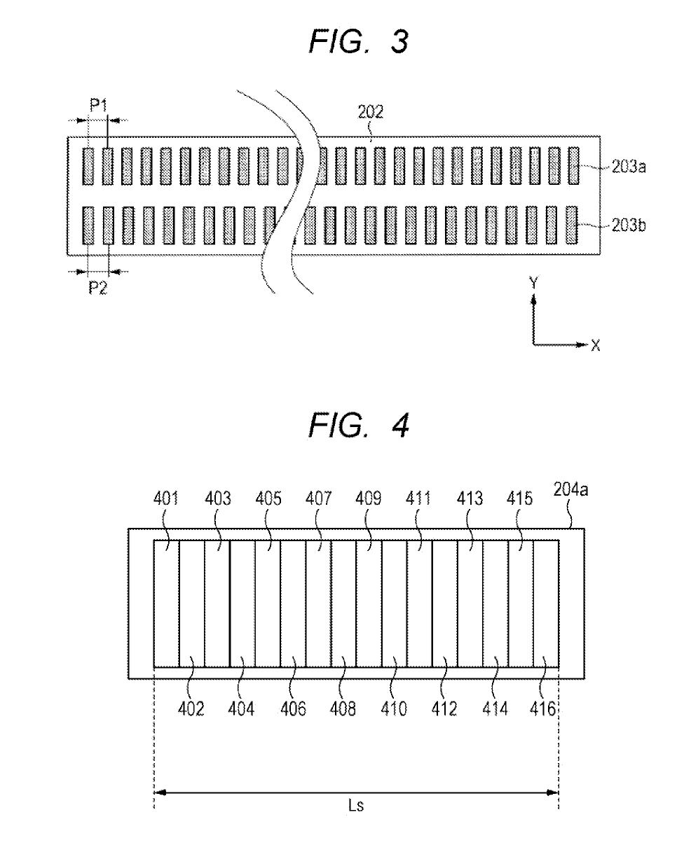

FIG. 3 is a plan view of the scale unit 202 according to the first embodiment. In FIG. 3, reflective type slit pattern arrays (reflective pattern arrays) are illustrated as an example. The scale unit 202 includes two pattern arrays, that is, a first pattern array 203a and a second pattern array 203b. The scale unit 202 is configured as follows. When the light emitted from the light source 201 enters reflective portions (black portions) of the pattern arrays 203a and 203b, the light is reflected to the respective light receivers 204a and 204b. The reflective portions of the first pattern array 203a are formed at equal pitches P1. The reflective portions of the second pattern array 203b are formed at equal pitches P2. In this embodiment, the pitch P1 is determined so that forty reflective portions are formed over a total length Lmax of the scale, that is, to have forty cycles over the total length L. The pitch P2 is determined so that thirty-nine reflective portions are formed over the total length Lmax of the scale, that is, to have thirty-nine cycles over the total length L.

FIG. 4 is a plan view of the light receiver 204a. The light receiver 204b has the same configuration as that of the light receiver 204a. Sixteen photodiodes 401 to 416 are arranged on the light receiver 204a at equal intervals in a horizontal direction. The photodiodes 401, 405, 409, and 413 are electrically connected to each other. A group formed by the photodiodes 401, 405, 409, and 413 is referred to as “phase a”. A group formed by the photodiodes 402, 406, 410, and 414 is referred to as “phase b”. Similarly, a group formed by the photodiodes 403, 407, 411, and 415 is referred to as “phase c”, and a group formed by the photodiodes 404, 408, 412, and 416 is referred to as “phase d”. This embodiment is described based on the presupposition that a length for four photodiodes included in the light receiver 204a in a direction of arrangement of the photodiodes (for example, a distance from an end of the photodiode 401 to an end of the photodiode 404) is twice as large as the pitch P1 of the reflective portions of the first pattern array 203a. An optical path length of light which is emitted from the light source 201 to the light receiver 204a becomes twice as large as an optical path length of light which is emitted from the light source 201 and reflected by the reflective portions of the first pattern array 203a. Therefore, a width of the reflected light received by the light receiver 204a is twice as large as the width at the reflective portion. Therefore, the width for the four photodiodes included in the light receiver 204a corresponds to one cycle of the pattern of the first pattern array 203a. Thus, the area of pattern arrays that can be read over the total length Ls of the photodiodes of the light receiver 204a corresponds to 4 pattern cycles of the first pattern array 203a.

When the light from the light source 201, which is reflected by the first pattern array 203a, is received by the light receiver 204a, the phase-a, phase-b, phase-c, and phase-d photodiode groups respectively output photo-electric currents corresponding to the received light amounts. With the movement of the scale unit 202 in the X-axis direction, the phase-a, phase-b, phase-c, and phase-d photodiode groups output the currents fluctuating in the following phase relationships. Specifically, with respect to the current in the phase a as a reference, the current fluctuates at 90° for the phase b, at 180° for the phase c, and at 270° for the phase d. The signal processing circuit 205 converts the output currents into voltages by a current-voltage converter. Next, the signal processing circuit 205 obtains a differential component between the phase a and the phase c and a differential component between the phase b and the phase d by a differential amplifier. Next, the signal processing circuit 205 generates, from the differential component between the phase a and the phase c and the differential component between the phase b and the phase d, a first A-phase displacement signal S1rA which is an A-phase displacement signal of the first pattern array 203a and a first B-phase displacement signal S1rB which is a B-phase displacement signal thereof whose phase is shifted by 90° from the phase of the first A-phase displacement signal S1rA. In a similar manner, for the light received by the light receiver 204b, a second A-phase displacement signal S2rA and a second B-phase displacement signal S2rB which are respectively an A-phase displacement signal and a B-phase displacement signal of the second pattern array 203b whose phases are shifted by 90° from each other are also generated.

The signal processing circuit 205 outputs any one of a set of the first A-phase displacement signal S1rA and the first B-phase displacement signal S1rB and a set of the second A-phase displacement signal S2rA and the second B-phase displacement signal S2rB in accordance with a switch-over signal from the read pattern switcher 103.

As described above, the ABS sensor 104 outputs any one of the set of the first A-phase displacement signal S1rA and the first B-phase displacement signal S1rB and the set of the second A-phase displacement signal S2rA and the second B-phase displacement signal S2rB in accordance with the switch-over signal from the read pattern switcher 103.

Next, an absolute position calculation method and a relative position calculation method are described.

The absolute position calculation and the relative position calculation are performed by the ABS/INC calculator 102.

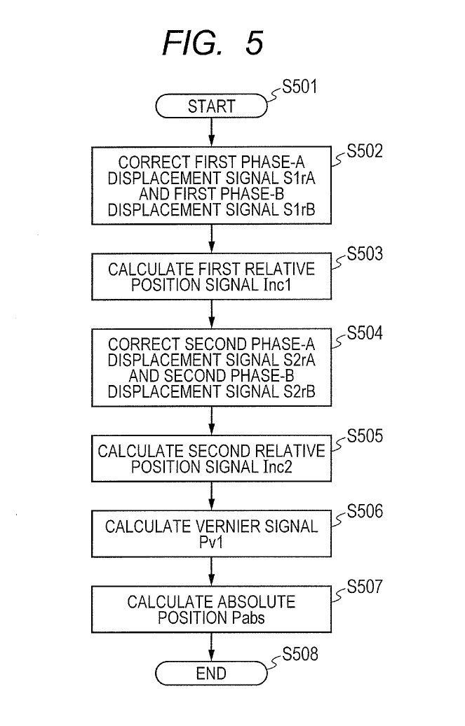

FIG. 5 illustrates a flow of the absolute position calculation.

In Step S501, the processing starts, and then proceeds to Step S502.

In Step S502, the first A-phase displacement signal S1rA and the first B-phase displacement signal S1rB are corrected.

The set of the first A-phase displacement signal S1rA and the first B-phase displacement signal S1rB or the set of the second A-phase displacement signal S2rA and the second B-phase displacement signal S2rB may have different signal offsets or signal amplitudes in some cases. If the signals having different signal offsets or signal amplitudes are directly used for the absolute position calculation, an error may be generated in the calculated absolute position value Pabs. Therefore, the signals are required to be corrected.

In this embodiment, as described above, the length for the four photodiodes included in the light receiver 204a in the direction of arrangement of the photodiodes (for example, the distance from the end of the photodiode 401 to the end of the photodiode 404) is twice as large as the pitch P1 of the reflective portions of the first pattern array 203a. Therefore, the first A-phase displacement signal S1rA and the first B-phase displacement signal S1rB are respectively expressed as Expressions (1) and (2) below.

S1rA: a1×cos θ+s1 (1)

S1rB: a2×sin θ+s2 (2)

In Expressions (1) and (2), symbol a1 is an amplitude of the first A-phase displacement signal S1rA and symbol s1 is an offset of the first A-phase displacement signal, symbol a2 is an amplitude of the first B-phase displacement signal S1rB and symbol s2 is an offset of the first B-phase displacement signal, and symbol θ is a phase of the signal. The first A-phase displacement signal S1rA has a maximum value of s1+a1, a minimum value of s1−a1, the signal amplitude of a1, and an average value of s1. Similarly, the second B-phase displacement signal s1rB has a maximum value of s2+a2, a minimum value of s2-a2, the signal amplitude of a2, and an average value of s2. By using the values described above, the first A-phase displacement signal S1rA and the first B-phase displacement signal S1rB respectively expressed by Expressions (1) and (2) are corrected. Then, a corrected first A-phase displacement signal S1cA and a corrected first B-phase displacement signal S1cB are expressed as Expressions (3) and (4) below.

S1cA: {(a1×cos θ+s1)−s1}×a2=a1×a2×cos θ (3)

S1cB: {(a2×sin θ+s2)−s2}×a1=a1×a2×sin θ (4)

As a result, the offsets of the first A-phase displacement signal S1rA and the first B-phase displacement signal S1rB are removed to obtain the first A-phase displacement signal S1cA and the first B-phase displacement signal S1cB having the same signal amplitude.

After the first A-phase displacement signal S1rA and the first B-phase displacement signal S1rB are corrected in Step S502 by the processing described above, the processing proceeds to Step S503.

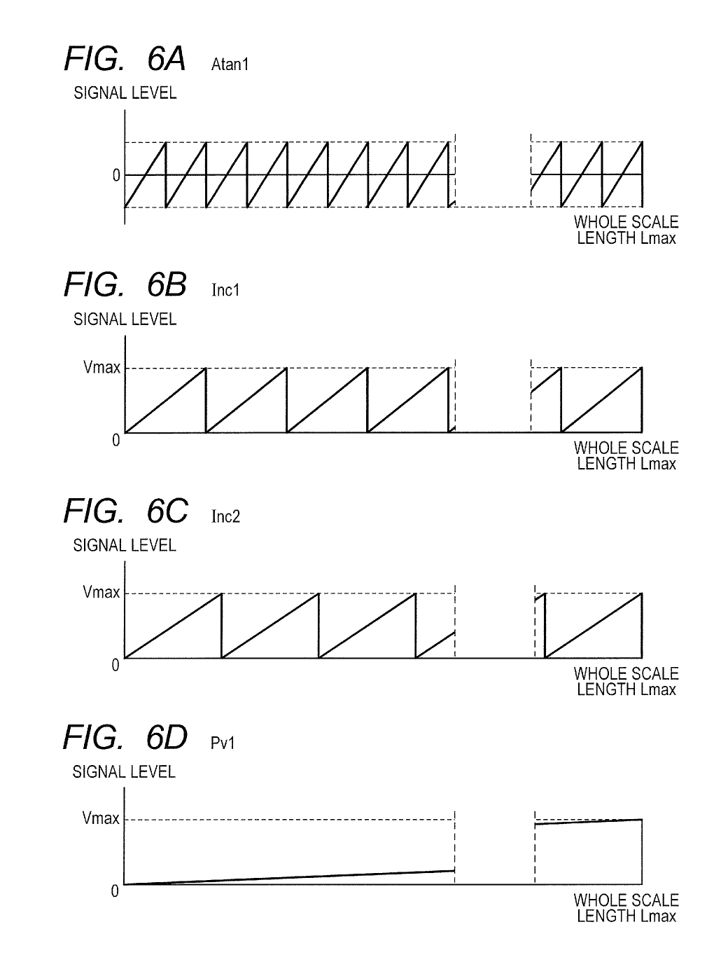

In Step S503, by using the corrected first A-phase displacement signal S1cA and the corrected first B-phase displacement signal S1cB, an arctangent calculation is performed to calculate a signal Atan1 as shown in FIG. 6A. The first pattern array 203a is a pattern array which has forty cycles over the total length Lmax of the scale. Therefore, the signal Atan1 has eighty cycles over the total length of the scale. Next, the first relative position signal Inc1 having forty cycles over the total length of the scale and the wave height Vmax is calculated from the signal Atan1. Specifically, a gain is applied to the signal Atan1 so that the wave height of the signal Atan1 becomes Vmax/2. The signal level is offset so that the signal level becomes 0 when the phase of the first B-phase displacement signal S1rB is at 0°. Then, by adding Vmax/2 when the phase is in the range from 180° to 360°, the first relative position signal Inc1 is calculated. Therefore, the first relative position signal Inc1 becomes a saw tooth wave having forty cycles over the total length Lmax of the scale, as shown in FIG. 6B. Accordingly, the first relative position signal Inc1 corresponding to the phase of the first pattern array 203a having the pitch P1 in one-by-one fashion is calculated by the ABS/INC calculator 102 (phase calculator).

In this case, each horizontal axis of FIGS. 6A, 6B, 6C, and 6D represents a position of the scale with respect to the total length Lmax, and each vertical axis thereof represents a signal level at the time.

In Step S503, the first relative position signal Inc1 is calculated. Then, the processing proceeds to Step S504.

In Step S504, the second A-phase displacement signal S2rA and the second B-phase displacement signal S2rB are corrected.

The light receiver 204b has the same configuration as the light receiver 204a. Therefore, the length for four photodiodes included in the light receiver 204b in the direction of arrangement of the photodiodes (for example, the distance from the end of the photodiode 401 to the end of the photodiode 404) is twice as large as the pitch P1 of the reflective portions of the first track pattern array 203a. The pitch P1 of the reflective portions of the first pattern array 203a and the pitch P2 of the reflective portions of the second pattern array 203b are different from each other. Therefore, the length for four photodiodes included in the light receiver 204b in the direction of arrangement of the photodiodes (for example, the distance from the end of the photodiode 401 to the end of the photodiode 404) does not become twice as large as the pitch P2 of the reflective portions of the second pattern array 203b. Therefore, the second A-phase displacement signal S2rA and the second B-phase displacement signal S2rB have a relationship in which the phase shift therebetween is not 90°.

Thus, the second A-phase displacement signal S2rA and the second B-phase displacement signal S2rB are respectively expressed by Expressions (5) and (6) below.

S2rA: b1×cos θ+t1 (5)

S2rB: b2×sin(θ+α)+t2 (6)

In Expressions (5) and (6), symbol b1 is an amplitude of the second A-phase displacement signal S2rA and symbol t1 is an offset of the second A-phase displacement signal S2rA, symbol b2 is an amplitude of the second B-phase displacement signal S2rB and symbol t2 is an offset of the second B-phase displacement signal S2rB, symbol θ is a phase of the signal, and symbol α is a shift amount of the phase. When the second A-phase displacement signal S2rA and the second B-phase displacement signal S2rB are corrected in the same manner as in the processing performed in Step S502, a corrected second A-phase displacement signal S2cA′ and a corrected second B-phase displacement signal S2cB′ are respectively expressed by Expressions (7) and (8) below.

S2cA′: {(b1×cos θ+t1)−t1}×b2=b1×b2×cos θ (7)

S2cB′: {(b2×sin(θ+α)+t2)−t2}×b1=b1×b2×sin(θ+α) (8)

As a result, the offset t1 of the second A-phase displacement signal S2rA and the offset t2 of the second B-phase displacement signal S2rB are removed to obtain the second A-phase displacement signal S2cA′ and the second B-phase displacement signal S2cB′ having the same signal amplitude.

Next, processing for setting a phase difference between the second A-phase displacement signal S2cA′ and the second B-phase displacement signal S2cB′ to 90° by using Expressions (7) and (8) is described below.

A difference between Expressions (7) and (8) and the sum of Expressions (7) and (8) are respectively expressed by Expressions (9) and (10) below.

b1×b2×(sin(θ+α)−cos θ)=b1×b2×2×sin {(α−90)/2}×cos {θ+(α+90)/2} (9)

b1×b2×(sin(θ+α)−cos θ)=b1×b2×2×cos {(α−90)/2}×sin {θ+(α+90)/2} (10)

The phase difference given by Expressions (9) and (10) becomes 90° by the calculations described above.

The amplitudes in Expressions (9) and (10) are different from each other. Therefore, the amplitudes are next corrected to calculate a second A-phase displacement signal S2cA and a second B-phase displacement signal S2cB having the same signal amplitude. Expression (9) is multiplied by cos {(α−90)/2} which is a part of the amplitude in Expression (10), and Expression (10) is multiplied by sin {(α−90)/2} which is a part of the amplitude in Expression (9). Then, Expressions (11) and (12) are obtained.

S2cA=b1×b2×2×sin {(α−90)/2}×cos {(α−90)/2}×cos {θ+(α+90)/2} (11)

S2cB=b1×b2×2×sin {(α−90)/2}×cos {(α−90)/2}×sin {θ+(α+90)/2} (12)

As a result, the offsets of the second A-phase displacement signal S2rA and the second B-phase displacement signal S2rB are removed so that the second A-phase displacement signal S2cA and the second B-phase displacement signal S2cB having the same signal amplitude are obtained.

After the second A-phase displacement signal S2rA and the second B-phase displacement signal S2rB are corrected in Step S504 by the processing described above, the processing proceeds to Step S505.

In Step S505, the same calculation as that performed in Step S503 is performed using the corrected second A-phase displacement signal S2cA and the corrected second B-phase displacement signal S2cB to calculate a second relative position signal Inc2. The second pattern array 203b is a pattern array having thirty-nine cycles over the total length Lmax of the scale. Therefore, the second relative position signal Inc2 becomes a saw tooth wave having thirty-nine cycles over the total length Lmax of the scale, as shown in FIG. 6C. Accordingly, the second relative position signal Inc2 corresponding to the phase of the second pattern array 203b having the pitch P2 in one-by-one fashion is calculated by the ABS/INC calculator 102 (phase calculator). The horizontal axis of FIG. 6C indicates the position on the total length Lmax of the scale, whereas the vertical axis indicates the signal level at the time.

The second relative position signal Inc2 is calculated in Step S505, and then, the processing proceeds to Step S506.

In Step S506, a difference between the first relative position signal Inc1 and the second relative position signal Inc2 is calculated. When the difference is a negative value, Vmax is added. Thus, a Vernier signal Pv1 is obtained as shown in FIG. 6D. In this case, a difference in the number of cycles between the first relative position signal Inc1 and the second relative position signal Inc2 over the total length Lmax is 1. Therefore, the Vernier signal Pv1 becomes a saw tooth wave having one cycle over the total length Lmax.

After the Vernier signal Pv1 is calculated in Step S506, the processing proceeds to Step S507.

In Step S507, the absolute position value Pabs is calculated.

The signals S1rA, S1rB, S2rA, and S2rB each contain a noise component due to a disturbance and the like. Therefore, the first relative position signal Inc1 and the second relative position signal Inc2 calculated from the signals S1rA, S1rB, S2rA, and S2rB also contain a noise component. The first relative position signal Inc1 and the second relative position signal Inc1 are not based on the signals S1rA, S1rB, S2rA, and S2rB that are obtained simultaneously, and hence there is a signal obtaining delay. In the case where the movable member 21 is moving during the signal obtaining delay time, a phase shift occurs in a signal. In order to correct an error component E caused by a noise component and a phase shift amount, the synchronism calculation of the Vernier signal Pv1 and the first relative position signal Inc1 is performed. As a result of the synchronism calculation, a signal synthesized through use of the Vernier signal Pv1 which is an upper-level signal and the first relative position signal Inc1 which is a lower-level signal is calculated as a signal level Vabs representing the absolute position. The absolute position value Pabs is calculated from the signal level Vabs. A method of calculating the absolute position value Pabs from the signal level Vabs is described later.

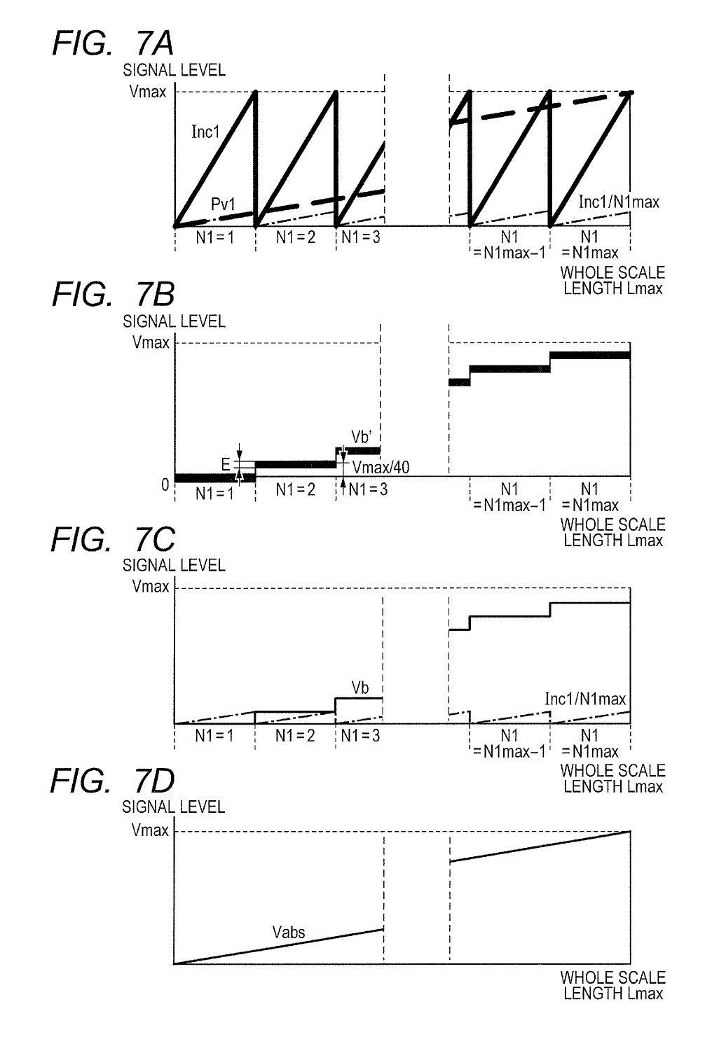

FIGS. 7A, 7B, 7C, and 7D show how the waveforms change by the synchronism calculation described above.

In FIGS. 7A, 7B, 7C, and 7D, the horizontal axis indicates the position on the total length Lmax of the scale, whereas the vertical axis indicates the signal level at the time. In addition, symbol Vmax indicates the maximum value of the signal level, and symbol N1 indicates a cycle number of a region from a start point of the scale. The maximum number of cycles is defined as N1max. In this embodiment, the first pattern array 203a has forty cycles over the total length Lmax of the scale. Therefore, N1max is 40, where N1 is a natural number ranging from 1 to 40.

FIG. 7A shows waveforms of Inc1, Pv1, and Inc1/N1max. When a difference between Pv1 and Inc1/N1max having the same gradient as Pv1 is taken, a step-like waveform containing the error component E shown in FIG. 7B is generated. A signal level Vb′ having the waveform shown in FIG. 7B is expressed by Expression (13). A signal level for one step of the step-like waveform is Vmax/N1max.

Vb′=Pv1−(Inc1/N1max) (13)

Next, the error component E of the waveform shown in FIG. 7B is removed by rounding. Then, a waveform shown in FIG. 7C is obtained. A signal level Vb having the waveform shown in FIG. 7C is expressed by Expression (14).

Vb=Round[{Pv1−(Inc1/N1max)}×(N1max/Vmax)]×(Vmax/N1max) (14)

where Round[ ] is a function for rounding off the first decimal place.

The error component E can be expressed by Expression (15).

E={Pv1−(Inc1/N1max)}−Vb (15)

The waveform of Inc1/N1max is added to the waveform of the signal level Vb shown in FIG. 7C to generate the signal level Vabs indicating the absolute position obtained by removing the error component E, as shown in FIG. 7D.

The synchronism calculation is performed by a calculation expressed by Expression (16).

Vabs=Vb+(Inc1/N1max) (16)

From the signal level Vabs indicating the absolute position, the absolute position value Pabs is expressed by Expression (17).

Pabs=Vabs×(Lmax/Vmax) (17)

In Step S507, the absolute position value Pabs is calculated, and then the processing proceeds to Step S508 and ends.

The absolute position value Pabs can be calculated as described above.

After the absolute position value Pabs is once obtained through the above-mentioned processing flow, in order to obtain a relative position, the ABS/INC calculator 102 instructs the read pattern switcher 103 to output the first A-phase displacement signal S1rA and the first B-phase displacement signal S1rB. In general, the relative position can be obtained, for example, by an incremental encoder or the like. In this case, the resolution is determined based on the fineness of a pulse to be generated (fineness of a read pattern). In the present invention, a phase in a pulse cycle can be obtained in addition to a pulse count through use of the first relative position signal Inc1 that is a periodic signal, and hence the position in a pulse cycle can also be specified. The ABS/INC calculator 102 calculates the first relative position signal Inc1 by the above-mentioned method based on the first A-phase displacement signal S1rA and the first B-phase displacement signal S1rB, and periodically calculates the relative position value Pinc based on the values of the first relative position signal Inc1 and the first relative position signal Inc1 used in the calculation of the absolute position value Pabs in Expression (17). The relative position value Pinc that is a relative displacement amount based on the absolute position value Pabs is represented by Expression (18):

Pinc={(Inc1_current−Inc1_base)/Vmax+N_{—}Inc1}×Lmax/N1max× (18)

where Inc1_base represents the first relative position signal Inc1 at a time of calculation of the absolute position value Pabs; Inc1_current represents the first relative position signal Inc1 at a time of calculation of the relative position; and N_Inc1 represents the accumulation of the number of times by which the first relative position signal Inc1 is switched between Vmax and (number of pulses) (note that, the number of times of switching from Vmax to 0 is defined to be positive, and the number of times of switching from 0 to Vmax is defined to be negative).

Accordingly, the ABS/INC calculator 102 always calculates the relative position value Pinc, except for the time period during which the absolute position value Pabs is calculated. Note that, in this embodiment, the calculation of the relative position value using the first relative position signal Inc1 has been described, but the present invention is not limited thereto. The relative position measured by any method can be applied to the present invention as long as the method is capable of measuring a known relative position.

A method of determining that the absolute position value Pabs is not correct by the ABS error detector 106 is described.

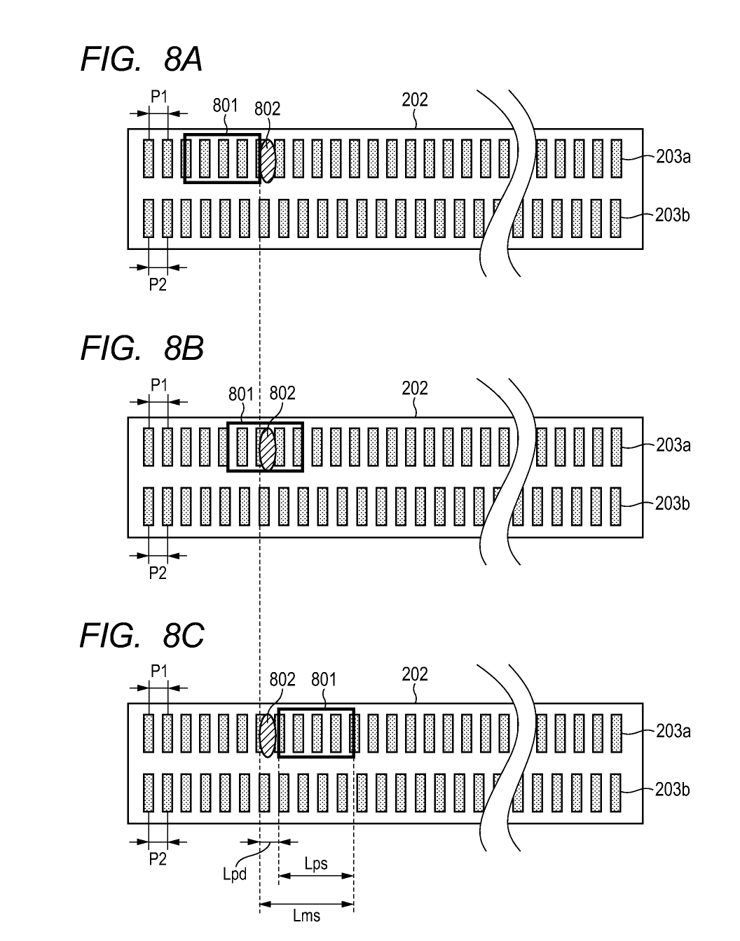

FIGS. 8A to 8C each illustrate a pattern read area 801 at a certain absolute position and the state of a foreign matter 802 on the scale unit 202 on a plan view of the scale unit 202 in this embodiment. In this embodiment, the pattern read area 801 corresponds to four cycles of the pattern of the pattern array 203a, and hence a width Lps of the pattern read area 801 in the X-direction is a length of P1×4. FIG. 8A illustrates the state in which the foreign matter 802 borders on the pattern read area 801 and the foreign matter 802 is not present in the pattern read area 801. FIG. 8B illustrates the state in which the foreign matter 802 is present in the pattern read area 801. FIG. 8C illustrates the state in which the foreign matter 802 borders on the pattern read area 801 on the opposite side of FIG. 8A and the foreign matter 802 is not present in the pattern read area 801. The movement amount of the pattern read area 801 of FIGS. 8A to 8C is defined as Lms. In the case where the movable member 21 moves in the X-direction, and the pattern read area 801 moves in the order of FIGS. 8A to 8C, the light received by the light receiver 204a of FIG. 4 is influenced by the foreign matter 802 in the movement range of the movement amount Lms in the pattern read area 801. As a result, a signal in a correct pattern is not read, and a malfunction is caused in which the absolute position value Pabs cannot be calculated correctly. In this case, when the width of the foreign matter 802 in the X-axis direction (length of an error occurring range in the movement direction) is defined as Lpd, the movement amount Lms is expressed by Expression (19).

Lms=Lps+Lpd (19)

Thus, in the case where the foreign matter 802 is present at any position in the pattern read area 801 at a certain absolute position, the foreign matter 802 is not present in the pattern read area 801 at the absolute position moved by the movement amount Lms or more. That is, the absolute position value Pabs at any one of the two absolute positions that are away from each other by the movement amount Lms or more is not influenced by the foreign matter 802, and thus the correct absolute position value Pabs is calculated.

In this case, when the maximum value of the width Lpd of an allowable foreign matter in the X-axis direction is defined as Lpdmax, a minimum movement amount (error recovering displacement amount) Lmsmin required for moving the absolute position to a position that is not influenced by the foreign matter 802 without fail can be set by Expression (20).

Lmsmin=Lps+Lpdmax (20)

The maximum value Lpdmax of the width of the allowable foreign matter in the X-axis direction is determined in advance based on the size of the maximum foreign matter to be mixed during the manufacturing of an absolute encoder, and the minimum movement amount Lmsmin corresponding thereto is held by the ABS error detector 106.

Accordingly, if the difference between the absolute position values Pabs and the difference between the relative position values Pinc at two positions that are away from each other by the minimum movement amount Lmsmin are matched with each other, it can be determined that any absolute position value Pabs at two absolute positions is calculated correctly. Further, if the difference between the absolute position values Pabs and the difference between the relative position values Pinc at certain two positions are not matched with each other, the absolute position value Pabs is calculated at a position away from any one of the two positions by the minimum movement amount Lmsmin or more. It can be determined that the absolute position values Pabs at two positions where the difference between the absolute position values Pabs and the difference between the relative position values Pinc among combinations of the three absolute positions are matched with each other are both calculated correctly.

Next, the error detection information Einfo of the absolute position is described.

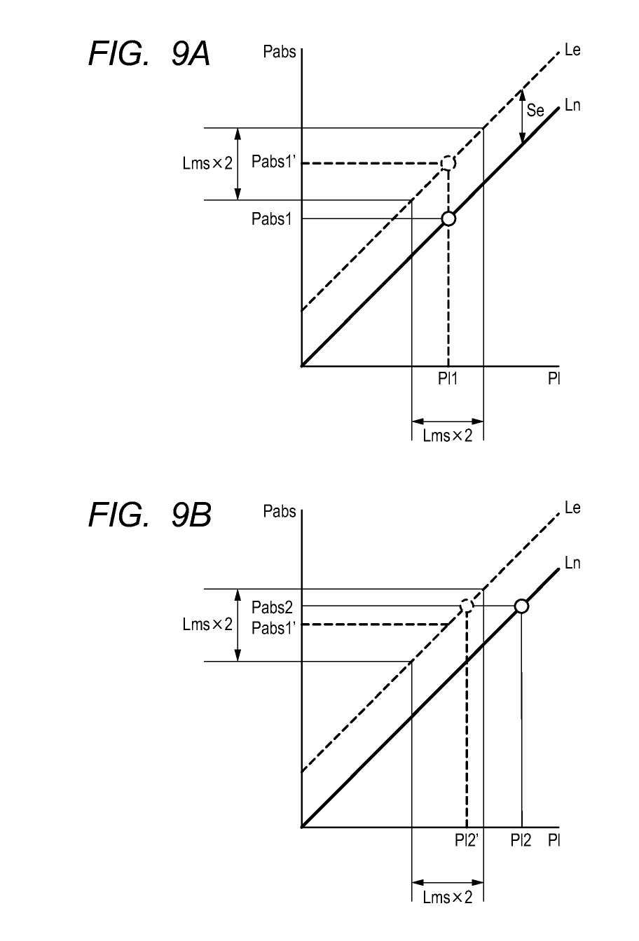

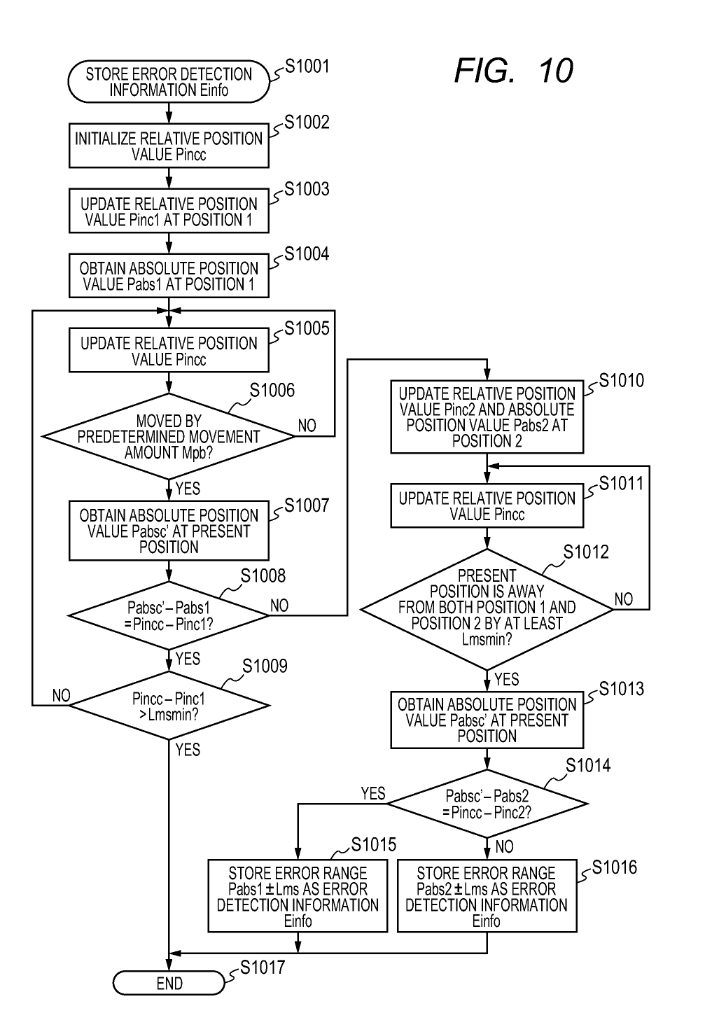

FIGS. 9A and 9B each show a relationship between an actual movable member position Pl and an absolute position value Pabs calculated by the ABS/INC calculator 102. The horizontal axis represents the actual movable member position Pl, and the vertical axis represents the absolute position value Pabs obtained by calculation. For convenience, it is assumed that the movable member position Pl and the absolute position value Pabs have a one-to-one relationship. Symbol Ln represents a line showing a relationship between the movable member position Pl and the absolute position value Pabs at a time when the correct absolute position value Pabs can be calculated with respect to the movable member position Pl. On the other hand, symbol Le represents a line showing a relationship between the movable member position Pl and the absolute position value Pabs at a time when the erroneous absolute position value Pabs is calculated with respect to the movable member position Pl (hereinafter referred to as “error calculation”). In this case, in the case where the error component E is a value beyond the range that can be removed by round-off calculation, the absolute position value Pabs is calculated erroneously as a value shifted from Ln by an error displacement amount Se by the calculation represented by Expression (14). In the case where it is calculated erroneously by the error calculation that there is the movable member position Pl at a position shifted by a waveform cycle shown in FIG. 7C, the error displacement amount Se is represented by the following Expression (21).

Se=Lmax/N1max (21)

The case where it is calculated erroneously by the error calculation that the movable member position Pl is present at the position shifted by a waveform cycle shown in FIG. 7C is hereinafter described.

FIG. 9A shows a relationship between the absolute position value Pabs1 calculated correctly at the movable member position Pl and an absolute position value Pabs1′ that cannot be calculated correctly due to the influence of the foreign matter 802. In this case, the difference between the absolute position value Pabs1 and the absolute position value Pabs1′ is Se.

As described above, in the range of the movement amount Lms, it can be determined that the absolute position value Pabs cannot be calculated correctly due to the influence of the foreign matter 802. Thus, the range of ±Lms with respect to the absolute position value Pabs1′ can be determined to be a range in which the absolute position value Pabs may not be calculated correctly due to the influence of the foreign matter 802.

FIG. 9B shows a relationship between the movable member position Pl2 at a time when Pabs2 is calculated correctly and the movable member position Pl2′ at a time when Pabs2 cannot be calculated correctly due to the influence of the foreign matter 802 in Pabs2 in which the absolute position value Pabs is within a range of ±Lms with respect to the absolute position value Pabs1′. In this case, the absolute position value Pabs that is within the range of ±Lms with respect to the absolute position value Pabs1′ exhibits the same value even at two movable member positions in the presence of the influence of the foreign matter 802 and in the absence of the influence of the foreign matter 802, which indicates that the movable member position cannot be calculated correctly.

Thus, the reliability of the absolute position value Pabs can be determined when the absolute position value Pabs is calculated next time by recording the range of ±Lms with respect to the absolute position value Pabs1′ that cannot be calculated correctly in the memory unit 107 as an error range. Specifically, in the case where the absolute position value Pabs obtained by calculation is within the range of ±Lms with respect to the absolute position value Pabs1′, it can be determined that there is a possibility that the absolute position value Pabs has been calculated erroneously.

Thus, the reliability of the calculated absolute position value Pabs can be checked based on the condition that the absolute position value Pabs calculated next time is beyond the range of the error detection information Einfo by storing the error range of the absolute positions calculated erroneously in the past as the error detection information Einfo.

FIG. 10 illustrates a flow at a time of storing the error detection information Einfo in this embodiment. The error detection information Einfo is detected by the ABS error detector 106 and stored in the memory unit 107.

In Step S1001, the processing starts, and then proceeds to Step S1002.

In Step S1002, the relative position value Pincc is initialized, and the processing proceeds to Step S1003. In the following, the absolute position in Step S1002 is defined as an initial position of a relative position, and the relative position value Pincc is updated as a relative position displacement amount from the initial position.

In Step S1003, the present relative position value Pincc is held as the relative position value Pinc1 at the position 1 with the present position being the position 1, and the processing proceeds to Step S1004.

In Step S1004, the absolute position value Pabs at the position 1 is calculated, and the calculated absolute position value Pabs is held as the absolute position value Pabs1. Then, the processing proceeds to Step S1005.

In Step S1005, the relative position value Pincc at the present position is updated, and the processing proceeds to Step S1006.

In Step S1006, when it is determined that the movable member 1204 has not moved from the position 1 or an absolute position value Pabsc calculation position (described later) by a predetermined movement amount Mpb, the processing returns to Step S1005, and otherwise the processing proceeds to Step S1007. In this case, the predetermined movement amount Mpb is any value equal to or less than the minimum movement amount Lmsmin.

In Step S1007, the absolute position value Pabs at the present position is calculated, and the calculated absolute position value Pabs is held as an absolute position value Pabsc′. Then, the processing proceeds to Step S1008.

In Step S1008, it is checked as to whether or not the difference between the absolute position value Pabsc′ at the present position and the absolute position value Pabs1 at the position 1 is matched with the difference between the relative position value Pincc at the present position and the relative position value Pinc1 at the position 1. In the case where the differences are matched with each other, the processing proceeds to Step S1009, and otherwise the processing proceeds to Step S1010.

In this case, in the case where the difference between the absolute position values and the difference between the relative position values are not matched with each other, it can be determined that an error has occurred in the calculation of the absolute position value at any of the present position and the position 1. That is, it can be determined that the foreign matter 802 is present somewhere in the pattern read area 801 at the current position or in the pattern read area 801 at the position 1.

In Step S1009, it is checked as to whether or not the present position has moved from the position 1 by the minimum movement amount Lmsmin or more. In the case where the present position has moved by the minimum movement amount Lmsmin or more, the processing proceeds to Step S1017 and ends. That is, this is the state in which it can be confirmed that the calculated absolute position value Pabs1 and absolute position value Pabsc′ are both positive values. The case where the movable member 1204 has not moved by the minimum movement amount Lmsmin or more corresponds to the state in which whether or not the calculated absolute position value is a correct value is not determined, and hence the processing returns to Step S1005.

In Step S1010, the relative position value Pincc at the present position is held as the relative position value Pinc2 at a position 2. Further, the absolute position value Pabsc′ at the present position is held as the absolute positive value Pabs2 at the position 2, and the processing proceeds to Step S1011.

In Step S1011, the relative position value Pincc at the present position is updated, and the processing proceeds to Step S1012.

In Step S1012, the processing proceeds to Step S1013 when the difference between the relative position value Pincc and the relative position value Pinc1 is equal to or more than the minimum movement amount Lmsmin, and the difference between the relative position value Pincc and the relative position value Pinc2 is equal to or more than the minimum movement amount Lmsmin. Specifically, in the case where the present position is away from both the position 1 and the position 2 by a predetermined displacement amount or more (minimum movement amount Lmsmin or more), the processing proceeds to Step S1013. In the case where the difference between the relative position value Pincc and the relative position value Pinc1 is equal to or more than the minimum movement amount Lmsmin, and the difference between the relative position value Pincc and the relative position value Pinc2 is not equal to or more than the minimum movement amount Lmsmin, the processing returns to Step S1011. That is, in the case where the present position is not away from the position 1 or the position 2 by the predetermined displacement amount or more (minimum movement amount Lmsmin or more), the processing returns to Step S1011.

In Step S1013, the absolute position value Pabs at the present position is calculated. The calculated absolute position value Pabs is held as the absolute position value Pabsc′, and the processing proceeds to Step S1014.

In Step S1014, it is checked as to whether or not the difference between the absolute position value Pabsc′ at the present position and the absolute position value Pabs2 at the position 2 is matched with the difference between the relative position value Pincc at the present position and the relative position value Pinc2 at the position 2. When the differences are matched with each other, the processing proceeds to Step S1015, and otherwise the processing proceeds to Step S1016.

In this case, when the difference between the absolute position values is matched with the difference between the relative position values, the absolute position value Pabs2 and the absolute position value Pabsc′ can be determined to be correct, and the absolute position value Pabs1 can be determined not to be correct. That is, it can be determined that the foreign matter 802 is present at any position in the pattern read area 801 at the position 1. On the other hand, when the differences are not matched with each other, the absolute position value Pabs1 and the absolute position value Pabsc′ can be determined to be correct, and the absolute position value Pabs2 can be determined not to be correct. That is, it can be determined that the foreign matter 802 is present at any position in the pattern read area 801 at the absolute position 2.

In Step S1015, the absolute position value Pabs2 is determined not to be correct, and the range of the absolute position value Pabs2±Lms is stored in the memory unit 107 as the error detection information Einfo. Then, the processing proceeds to Step S1017.

In Step S1016, the absolute position value Pabs1 is determined not to be correct, and the range of the absolute position value Pabs2±Lms is stored in the memory unit 107 as the error detection information Einfo. Then, the processing proceeds to Step S1017.

In Step S1016, the processing ends.

Thereafter, the reference absolute position value Pabsb is set as the absolute position value Pabs determined to be correct, and the reference relative position value Pincb is set as the relative position value Pinc determined to be correct. Then, the present absolute position value Pabsc is determined based on the reference absolute position value Pabsb, the reference relative position value Pincb, and the present relative position value Pincc. The present absolute position value Pabsc is represented by Expression (22).

Pabsc=Pabsb+(Pincc−Pincb) (22)

Next, a method of determining an absolute position by the ABS determinator 101 is described.

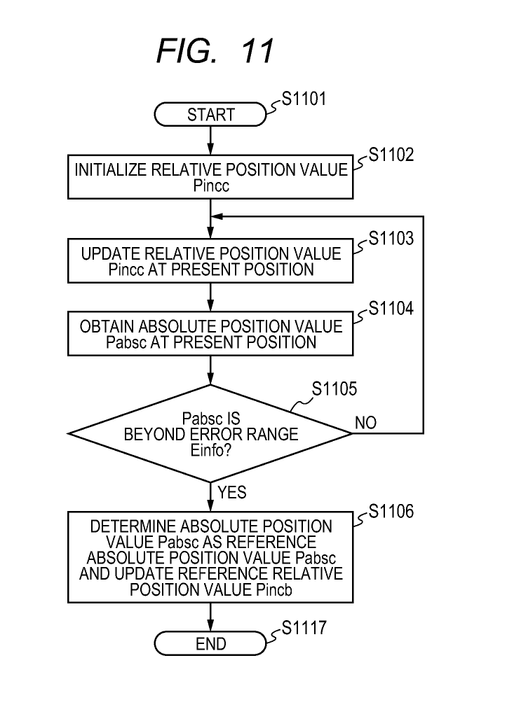

FIG. 11 illustrates an absolute position determination flow using the error detection information Einfo in this embodiment.

In Step S1101, the processing starts, and then proceeds to Step S1102.

In Step S1102, the relative position value Pincc is initialized, and the processing proceeds to Step S1103. The relative position value Pincc is updated as the relative position displacement amount from an initial position, with the absolute position in Step S1102 being the initial position of the relative position.

In Step S1103, the present relative position value Pincc is updated, and the processing proceeds to Step S1104.

In Step S1104, the present absolute position value Pabsc is calculated, and the processing proceeds to Step S1105.

In Step S1105, it is determined whether or not the present absolute position value Pabsc is within the error range recorded in the error detection information Einfo. When the present absolute position value Pabsc is not included in the error range, it is determined that the correct absolute position value has been calculated, and the processing proceeds to Step S1106. When the present absolute position value Pabsc is within the error range, the processing returns to Step S1103.

In Step S1106, the present absolute position value Pabsc is set as the reference absolute position value Pabsb, and the present relative position value Pincc is set as the reference relative position value Pincb. Then, the processing proceeds to Step S1117.

In Step S1117, the processing ends.

Then, the present absolute position value Pabsc is determined based on the reference absolute position value Pabsb, the reference relative position value Pincb, and the present relative position value Pincc.

Accordingly, an absolute position having high reliability can be calculated while erroneous absolute position calculation can be prevented even in the case where motes and scratches are present on the scale in the Vernier type position detecting apparatus.

### Second Embodiment

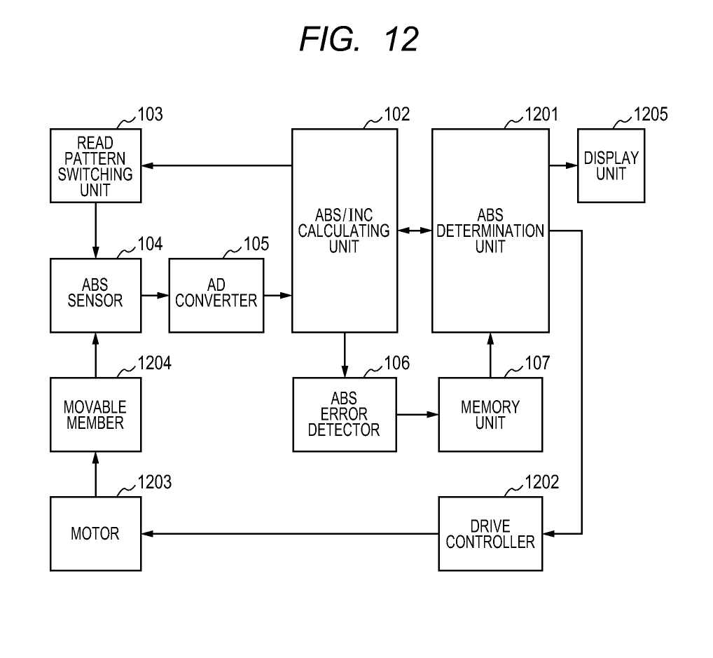

Next, a second embodiment of the present invention is described with reference to FIG. 12.

FIG. 12 is a configuration block diagram of this embodiment, and the components having the same configurations as those of FIG. 1 are denoted by the same reference symbols.

An ABS determinator 1201 is an absolute position determinator for determining the present absolute position Pabsc based on the absolute position value Pabs and the relative position value Pinc calculated by the ABS/INC calculator 102, and is different in operation from the ABS determinator 101. A drive controller 1202 is a drive controller for driving and controlling the movable member 1204. A motor 1203 is configured to drive the movable member 1204, and examples thereof include a DC motor and a stepping motor. The movable member 1204 is subjected to absolute position detection by the ABS sensor 104. A display unit 1205 is configured to display the error detection information Einfo to outside, and a liquid crystal display is given as an example.

Next, an operation of this embodiment is described.

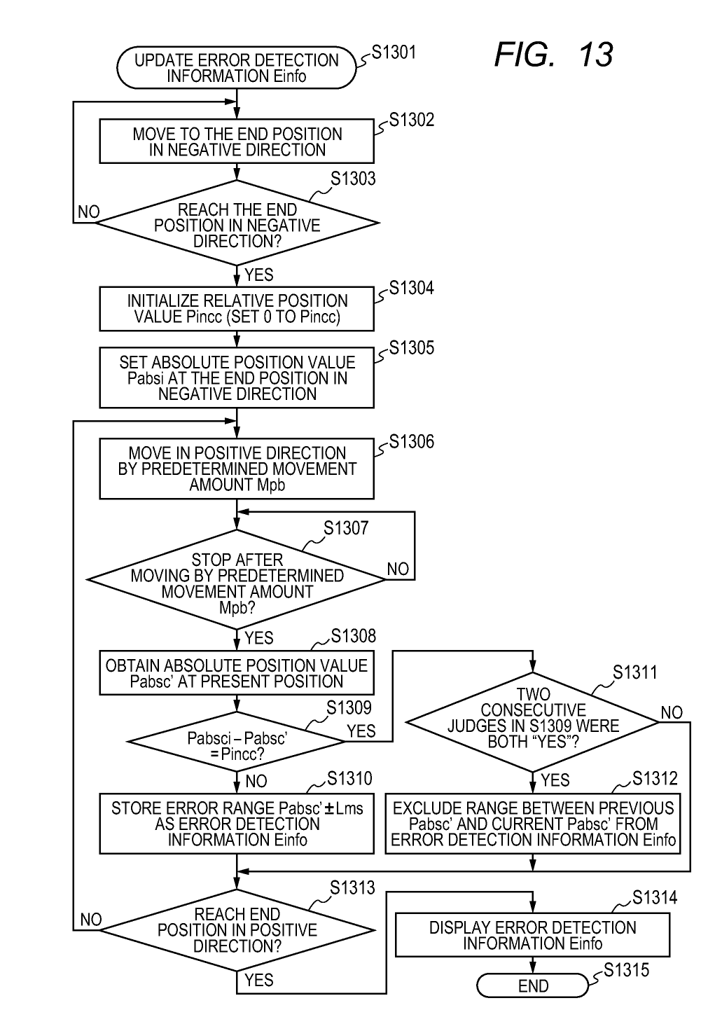

FIG. 13 illustrates an error detection information Einfo update flow in this embodiment.

In the error detection information Einfo update flow, the movable member 1204 is driven from an end position in a negative direction to an end position in a positive direction. Whether or not an absolute position value at each absolute position has been calculated correctly is detected, and the error detection information Einfo is updated based on the detection result. The operation of this embodiment is performed at a time when the user issues an instruction of update of the error detection information Einfo with a trigger such as a switch (not shown).

A flow of updating the error detection information Einfo is hereinafter described.

In Step S1301, the processing starts, and then proceeds to Step S1302.

In Step S1302, the ABS determinator 1201 instructs the drive controller 1202 to drive the movable member 1204 to the end position in the negative direction and proceeds to Step S1303. The drive controller 1202 drives the motor 1203 in response to the instruction and drives the movable member 1204 to the end position in the negative direction.

In Step S1303, whether or not the movable member 1204 has reached the end position in the negative direction is checked. When the movable member 1204 has reached the end position in the negative direction, the processing proceeds to Step S1304, and otherwise the processing returns to Step S1302.

In Step S1304, the relative position value Pincc is initialized, and the processing proceeds to Step S1305. Specifically, the relative position value Pincc is set to 0. The relative position value Pincc is updated as the relative position displacement amount from an initial position, with the absolute position in Step S1304 being the initial position of the relative position hereinafter.

In Step S1305, the absolute position value Pabs at the end position in the negative direction is set. The position of the movable member 21 is a position of an end. Therefore, a predetermined absolute position value is held as the absolute position value Pabsi without calculating an absolute position, and the processing proceeds to Step S1306.

In Step S1306, the ABS determinator 1201 instructs the drive controller 1202 to drive the movable member 1204 by a predetermined drive amount Mpb in the positive direction, and the processing proceeds to Step S1307. In this case, the predetermined movement amount Mpb is defined as any value equal to or less than the minimum movement amount Lmsmin.

In Step S1307, whether or not the movable member 1204 has been driven by the predetermined movement amount Mpb and stopped is checked. When the movable member 1204 has been driven by the predetermined movement amount Mpb and stopped, the processing proceeds to Step S1308. When the movable member 1204 has not been driven by the predetermined movement amount Mpb or stopped, the processing returns to Step S1307.

In Step S1308, the absolute position value Pabs at the present position is calculated. The calculated absolute position value Pabs is held as the absolute position value Pabsc′, and the processing proceeds to Step S1309.

In Step S1309, whether or not a difference between the absolute position value Pabsc′ at the present position and the absolute position value Pabsi is matched with the relative position value Pincc is checked. When the differences are matched with each other, the processing proceeds to Step S1311, and otherwise the processing proceeds to Step S1310.

In Step S1310, it is determined that the absolute position value Pabsc′ at the present position is not correct. Then, the range of the absolute position value Pabsc′±Lms is held in the memory unit 107 as the error detection information Einfo, and the processing proceeds to Step S1313.

In Step S1311, it is determined whether or not the determination in Step S1309 is Yes twice consecutively. That is, it is determined whether or not the calculated values of the absolute positions at positions that are away from each other by the predetermined movement amount Mpb that is any value equal to or less than the minimum movement amount Lmsmin are both correct values. When the determination is positive, the processing proceeds to Step S1312, and otherwise the processing proceeds to Step S1313.

In Step S1312, when the range of from the previous absolute position value Pabsc′ to the present absolute position value Pabsc′ falls within the error detection information Einfo, that portion is deleted from the error detection information Einfo, and the processing proceeds to Step S1313.

In Step S1313, whether or not the movable member 1204 has reached the end position in the positive direction is checked. When the movable member 1204 has reached the end position in the positive direction, the processing proceeds to Step S1314, and otherwise the processing returns to Step S1306.

In Step S1314, the ABS determinator 1201 reads the error detection information Einfo stored in the memory unit 107 and displays the information held in the error detection information Einfo to the display unit 1205. Then, the processing proceeds to Step S1315.

In Step S1315, the processing ends.

In this embodiment, in the case where the absolute position values at positions that are away from each other by the predetermined movement amount Mpb that is any value equal to or less than the minimum movement amount Lmsmin are both correct, that range is deleted from the error detection information Einfo. Note that, at this time, in the case where the movable member 1204 is driven and it is determined that the absolute position value Pabsc′ at the present position is correct in the entire error range, the error range including the absolute position value Pabsc′ may be deleted from the error detection information Einfo.

Further, in this embodiment, the absolute position value Pabs is calculated while the movable member 1204 stops. Note that, the purpose of the processing is to enhance the accuracy of the absolute position value Pabs, and hence the absolute position value Pabs may be calculated when the movable member 1204 is being driven as long as the accuracy of the absolute position value Pabs is ensured.

Further, in the procedure in this embodiment, an example in which the error detection information Einfo is updated by driving the movable member 1204 from the end in the positive direction to the end in the negative direction has been described. However, the movable member 1204 may be driven in any direction. Further, after detecting that the movable member 1204 has stopped during normal use, the error detection information Einfo may be updated with the same processing as that in Steps S1307 to S1312. In this case, the processing in Step S1304 and the processing in Step S1305 are performed at a start-up position.

Further, in this embodiment, the movable member 1204 is first moved to the end, and then the error detection position is checked regarding the entire movable range. However, the present invention is not limited thereto. The same effect can be obtained by moving the movable member 1204 to both ends in accordance with the flowchart of FIG. 13, with the position other than the end position, where a correct absolute position value can be obtained, being the start position, based on the absolute position at the position where the correct absolute position value can be obtained in accordance with the method of the first embodiment or the like without first moving the movable member 1204 to the end.

Further, in this embodiment, the error range is held as the error detection information Einfo. Further, information required for error detection may be held as the error detection information Einfo. Specifically, the absolute position value Pabs1′ determined to be an error, and information regarding whether or not the verified absolute position value Pabs is an error may be held as the error detection information Einfo. Further, the error component E at a time when the verified absolute position value Pabs is calculated, and the difference between the absolute position value Pabsc′ at the present position and the absolute position value Pabsi may be held as the error detection information Einfo.

In the case where a power source is turned off while the calculated absolute position value falls within the range which ranges the movement amount Lms with respect to the absolute position value detected as error detection, when the power source is turned on again while the fixed member and the movable member remain at the same positions, the absolute position value calculated by the ABS/INC calculator 102 immediately after the turn-on of the power source is detected as error detection unless motes have moved. In the position detecting apparatus of the present invention, the absolute position value recorded to be error detection as the error detection information Einfo is stored in the memory unit 107. Therefore, in the case where the power source is turned off while the calculated absolute position value falls within the range which ranges the movement amount Lms with respect to the absolute position value detected as error detection, it is appropriate that the power source be turned off after the movable member 1204 is moved by the driving unit beyond the range which ranges the movement amount Lms with respect to the absolute position as the error detection position recorded in the error detection information Einfo. With this, when the power source is turned on again, an absolute position can be detected without error detection immediately after the turn-on of the power source.

Accordingly, in the Vernier type position detecting apparatus, the influence of motes and scratches on the scale can be checked in advance.

Further, in the above-mentioned embodiments, although the example of using an optical encoder as an encoder has been described, the present invention is not limited thereto, and a magnetic or electrostatic encoder may be used.

A lens apparatus capable of exhibiting the effect of the present invention can be realized by applying the position detecting apparatus of the embodiments to a lens apparatus including a movable optical member so as to detect the position of the movable optical member. Further, an image pickup apparatus capable of exhibiting the effect of the present invention can be realized by applying the position detecting apparatus of the embodiments to an image pickup apparatus including a lens apparatus including a movable optical member and a camera apparatus so as to detect the position of the movable optical member.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-234387, filed Nov. 12, 2013, which is hereby incorporated by reference herein in its entirety.

What is claimed is:

1. A position detecting apparatus which detects a relative position, relative to a base member, of a movable member which relatively moves in a movement direction relative to the base member, comprising:
a scale formed on one of the base member and the movable member, the scale comprising a first pattern array including a plurality of first patterns arranged in a first cycle in the movement direction and a second pattern array including a plurality of second patterns arranged in a second cycle different from the first cycle in the movement direction;
an obtaining unit mounted on the other of the base member and the movable member, and configured to obtain a plurality of signals including a first signal based on the first pattern array and a second signal based on the second pattern array;
a position calculator configured to calculate an absolute position of the movable member with respect to the base member based on the plurality of signals;
a determinator configured to determine whether or not the absolute position calculated by the position calculator is correct; and
a memory configured to store an information for determining whether or not the absolute position calculated by the position calculator is correct,
wherein the determinator determines whether or not the absolute position calculated by the position calculator is correct, based on the information stored in the memory.

2. The position detecting apparatus according to claim 1, wherein the memory stores a calculation information of the position calculator at a time when the determinator determines the absolute position calculated by the position calculator is not correct.

3. The position detecting apparatus according to claim 1,
wherein the error detection information comprises a past absolute position calculated by the position calculator and determined to be detected erroneously by the determinator, and
wherein, when the absolute position calculated by the position calculator is beyond a predetermined range with reference to an absolute position stored as the error detection information, the absolute position determinator determines the calculated absolute position as a present absolute position.

4. The position detecting apparatus according to claim 1, wherein, when the absolute position determined as error detection by the determinator and calculated by the position calculator is different from the error detection information stored in the memory, the error detection information is updated.

5. The position detecting apparatus according to claim 1, further comprising:
a driving unit configured to drive the obtaining unit in the movement direction with respect to the scale; and
a drive controller configured to control the driving unit,
wherein the drive controller turns off a power source after controlling the driving unit so that the driving unit drives the obtaining unit beyond a predetermined range from the absolute position held in the memory as the error detection information.

6. The position detecting apparatus according to claim 1, further comprising a unit configured to output the error detection information to outside.

7. The position detecting apparatus according to claim 1, further comprising a relative position calculator configured to calculate a displacement amount of the scale with respect to the obtaining unit,
wherein, when a difference between an absolute position calculated by the position calculator at a first position and an absolute position calculated by the position calculator at a second position is different from a displacement amount between the first position and the second position calculated by the relative position calculator, the determinator determines that any one of the absolute positions detected at the first position and the second position has been detected erroneously.

8. The position detecting apparatus according to claim 7, wherein, when the difference between the absolute position calculated by the position calculator at the first position and the absolute position calculated by the position calculator at the second position is different from the displacement amount between the first position and the second position calculated by the relative position calculator, the determinator determines that the absolute position at one of the first position and the second position exhibiting a value different from an absolute position calculated by the position calculator at a third position that is separated away from both the first position and the second position by a predetermined displacement amount or more has been detected erroneously.

9. The position detecting apparatus according to claim 8, wherein, when the difference between the absolute position calculated by the position calculator at the first position and the absolute position calculated by the position calculator at the second position is different from the displacement amount between the first position and the second position calculated by the relative position calculator, if the obtaining unit stops with respect to the scale, the determinator determines that the absolute position at one of the first position and the second position exhibiting the value different from the absolute position calculated by the position calculator at the third position that is separated away from both the first position and the second position by the predetermined displacement amount or more has been detected erroneously.

10. A lens apparatus, comprising:
a movable optical member; and
a position detecting apparatus serving as a position detecting apparatus for the movable optical member, the position detecting apparatus which detects a relative position, relative to a base member, of a movable member which relatively moves in a movement direction relative to the base member, comprising:
a scale formed on one of the base member and the movable member, the scale comprising a first pattern array including a plurality of first patterns arranged in a first cycle in the movement direction and a second pattern array including a plurality of second patterns arranged in a second cycle different from the first cycle in the movement direction;
an obtaining unit mounted on the other of the base member and the movable member, and configured to obtain a plurality of signals including a first signal based on the first pattern array and a second signal based on the second pattern array;
a position calculator configured to calculate an absolute position of the movable member with respect to the base member based on the plurality of signals;
a determinator configured to determine whether or not the absolute position calculated by the position calculator is correct; and
a memory configured to store an information for determining whether or not the absolute position calculated by the position calculator is correct,
wherein the determinator determines whether or not the absolute position calculated by the position calculator is correct, based on the information stored in the memory.

11. An image pickup apparatus, comprising:
a lens apparatus comprising:
a movable optical member; and
a position detecting apparatus serving as a position detecting apparatus for the movable optical member, the position detecting apparatus which detects a relative position, relative to a base member, of a movable member which relatively moves in a movement direction relative to the base member, comprising:
a scale formed on one of the base member and the movable member, the scale comprising a first pattern array including a plurality of first patterns arranged in a first cycle in the movement direction and a second pattern array including a plurality of second patterns arranged in a second cycle different from the first cycle in the movement direction;
an obtaining unit mounted on the other of the base member and the movable member, and configured to obtain a plurality of signals including a first signal based on the first pattern array and a second signal based on the second pattern array;
a position calculator configured to calculate an absolute position of the movable member with respect to the base member based on the plurality of signals;
a determinator configured to determine whether or not the absolute position calculated by the position calculator is correct; and
a memory configured to store an information for determining whether or not the absolute position calculated by the position calculator is correct,
wherein the determinator determines whether or not the absolute position calculated by the position calculator is correct, based on the information stored in the memory; and
a camera apparatus.
